(19) United States
(12) Patent Application Publication
(10) Pub. No.: US 2011/0087670 A1
(43) Pub. Date: Apr. 14, 2011

(54) SYSTEMS AND METHODS FOR CONCEPT MAPPING

(76) Inventors: Gregory Jorstad, Mt. Pleasant, SC (US); Matthew Aldridge, Charleston, SC (US); Theodore Calhoun Tanner, JR., Hollywood, SC (US)

(21) Appl. No.: 12/534,676

(22) Filed: Aug. 3, 2009

Related U.S. Application Data
(60) Provisional application No. 61/086,335, filed on Aug. 5, 2008.

(51) Int. Cl. G06F 17/30

(52) U.S. Cl. 707/741; 707/798; 707/E17.002; 707/E17.011

(57) ABSTRACT

Concepts relevant to natural language content may be identified using an ontology. The natural language content may be tokenized and normalized. Using the tokenized content, one or more candidate concepts within the ontology may be identified. Concepts relevant to the natural language content may be selected using the identified concepts and the relationships between concepts defined within the ontology. A spreading activation process may be used to identify related concepts. The spreading activation process may be iterative and/or may reach multiple generations of connected concepts within the ontology. The relevant concepts associated with the natural language content may be used to index the natural content, identify related content, provide targeting advertising related to the natural language content, and the like.

### CROSS-REFERENCE TO RELATED APPLICATIONS

This application claims the benefit of U.S. Provisional Application No. 61/086,335, filed Aug. 5, 2008, and entitled “Systems and Methods for Concept Mapping,” which is hereby incorporated by reference in its entirety.

### TECHNICAL FIELD

This disclosure relates to systems and methods for classifying content using concepts associated with the content and, in particular, to systems and methods for mapping one or more terms and/or phrases in the natural language content to one or more concepts.

### BRIEF DESCRIPTION OF THE DRAWINGS

Additional aspects and advantages will be apparent from the following detailed description of preferred embodiments, which proceeds with reference to the accompanying drawings, in which:

FIG. 1 is a block diagram of one embodiment of a system for extracting conceptual meaning from natural language content;

FIG. 2 is a flow diagram of one embodiment of a method for identifying concept candidates;

FIG. 3A is a data flow diagram of concept candidate selection;

FIG. 3B is a flow diagram of one embodiment of a method for identifying concept candidates within natural language content;

FIG. 4A is a data flow diagram of an ontology graph comprising activation values;

FIG. 4B is a data flow diagram of an ontology graph comprising activation values;

FIG. 4C is a flow diagram of one embodiment of a method for generating an activation map;

FIG. 5 is a flow diagram of one embodiment of a method for generating an activation map;

FIG. 6A is a data flow diagram of an ontology graph comprising activation values;

FIG. 6B is a data flow diagram of an ontology graph comprising activation values;

FIG. 7 is a flow diagram of one embodiment of a method for identifying and using conceptual information extracted from natural language content; and

FIG. 8 is a block diagram of one embodiment of a system for selecting one or more concepts relevant to natural language content.

### DETAILED DESCRIPTION OF PREFERRED EMBODIMENTS

Concept extraction may refer to a process of extracting conceptual meaning (semantics) from natural language content, such as a text document, speech, or the like. Extracting conceptual meaning of individual words within natural language content may be difficult, since the meaning of any particular word or phrase may be dependent upon the context in which the word or phrase is used. For example, the terms in the text, “raid kills bugs dead” may be interpreted in a number of different ways. The term “raid” may refer to a military or police action (e.g., a “sudden attack, as upon something to be seized or suppressed”), a business tactic (e.g., “a large-scale effort to lure away a competitor's employees, members, etc.”), or a particular brand of pest killer (e.g., Raid® brand pest control products). Similarly, the term “bug” may have various meanings depending upon how it is used (e.g., software bug, an insect, and so on).

The proper meaning for the terms in the text may be extracted by determining a “concept” associated with the text. Once the correct concept is found, related concepts may be extracted (e.g., the context provided by concepts identified in the text may be used to extract further concepts from the text).

Concept extraction may be useful in many commercial contexts, such as identifying related content, providing targeted advertising, and the like. As used herein, related content may refer to content that is related to a particular set of natural language content. As used herein, related content may comprise any number of different types of content, including, but not limited to: another set of natural language content (e.g., an article, web page, book, document or the like), multimedia content (e.g., image content, video, audio, an animation), interactive content (e.g., a Flash® application, an executable program, or the like), a link, advertising, or the like. The related content may be associated with one or more concepts a priori and/or using the systems and methods disclose herein. Content related to a set of natural language content (related content) may be identified by comparing concepts associated with the natural language content (as determined by the systems and methods disclosed therein) to concepts associated with the related content.

Concept extraction may also be used to provide relevant search results. For example, a search performed by a user may return search results relevant to a particular interest area (e.g., concept) even if the content itself does not contain any of the terms used to formulate the search. This may be possible by indexing the natural language content based on one or more concepts related to the content rather than to any particular terms that appear in the content. Similarly, advertising displayed in connection with the content may be selected based on one or more concepts relevant to the content. The advertising may be directed to a particular interest area related to the content even if common terms associated with the particular interest area do not appear in the content.

As used herein, a concept may refer to a single, specific meaning of a particular word or phrase. The word or phrase itself may comprise simple text that is capable of taking on one of a plurality of different meanings. For instance, in the example above, the word “raid” may refer to any number of meanings (e.g., a particular type of military action, a particular type of police action, a brand of insecticide, and so on). The concept, however, associated with “raid” in the example phrase is singular; the term refers to the concept of Raid® brand insecticide.

As used herein, natural language content may refer to any language content including, but not limited to: text, speech (e.g., audio translated into text form), or the like. Natural language content may be fundamentally noisy data, meaning that language elements, such as words and phrases within the content may have the potential to refer to multiple, different meanings (e.g., refer to multiple, different concepts).

As used herein, disambiguation may refer to determining or identifying the “true” meaning of a term or phrase that has the potential of referring to multiple, different meanings. In the above example, disambiguation may refer to determining that the term “raid” refers to a particular concept (e.g., “Raid® brand insecticide”) rather than to another possible concept (e.g., a military raid, a gaming raid, or the like).

As used herein, an ontology may refer to an organized collection of precompiled knowledge referring to both the meaning of terms (e.g., concepts) and relationships between concepts. In some embodiments, an ontology may comprise a graph having a plurality of vertices (e.g., nodes) interconnected by one or more edges. The vertices within the ontology graph may be concepts within the ontology, and the edges interconnecting the vertices may represent relationships between related concepts within the ontology.

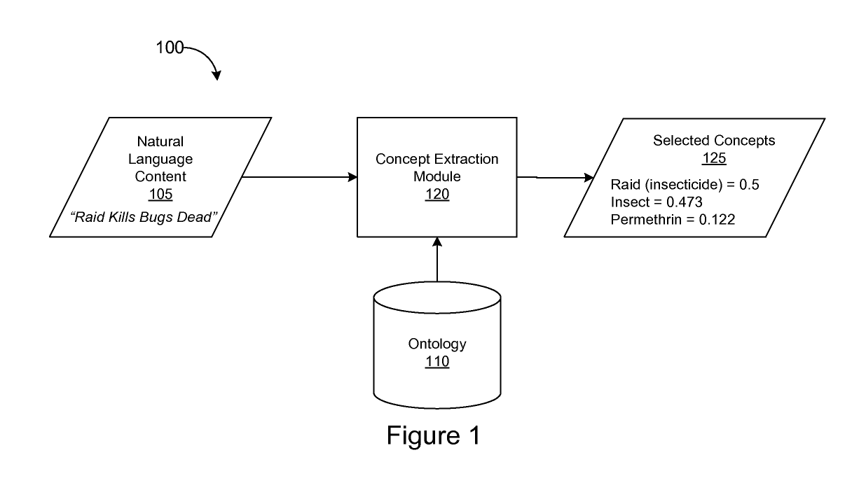

FIG. 1 depicts a block diagram of a system 100 for extracting conceptual meaning from natural language content. The system 100 may comprise an ontology 110, which may comprise precompiled knowledge relating particular natural language words (e.g., tokens) and/or phrases to concepts. As used herein, a token may refer to a term (e.g., single word) or phrase (e.g., multiple words). The ontology 110 may be stored on a computer-readable storage medium, comprising one or more discs, flash memories, databases, optical storage media, or the like. Accordingly, the data structures comprising the ontology 110 (e.g., the graph structure comprising a plurality of vertices interconnected by one or more edges) may be embodied on the computer-readable storage medium.

In the FIG. 1 embodiment, unstructured, natural language content 105 (e.g., such as “raid kills bugs dead”) may flow to a concept extractor module 120. The concept extraction module 120 may be implemented in conjunction with a special- and/or general-purpose computing device comprising a processor (not shown).

The concept extraction module 120 may be configured to receive natural language content 105 (e.g., text content), tokenize the content 105 (e.g., parse the content into individual words and/or phrases), and map the tokenized content to one or more concepts within the ontology 110. Mapping the tokenized content onto the ontology 100 may comprise the concept extraction module 120 generating one or more selected concepts 125. The selected concepts 125 may represent a set of one or more concepts that are relevant to the natural language content 105 (e.g., the selected concepts 125 may indicate a conceptual meaning of the natural language content 105). The selected concepts 125 may be embodied as a list or other data structure comprising a set of concepts selected from the ontology 110 (e.g., as an activation map having one or more vertices (or references to vertices), which may correspond to concepts within the ontology 110). In some embodiments, the concepts within the set of selected concepts 125 may be assigned a respective activation value, which may indicate a relevance level of the concept within the context of the natural language content 105.

As discussed above, the conceptual meaning of some words or phrases (e.g., tokens) within the natural language content 105 may be ambiguous. As used herein, the conceptual meaning of a natural language token may be referred to as ambiguous if the token may refer to more than one concept within the ontology. For example, the term “Raid” discussed above may be referred to as an ambiguous token since it may refer to several different concepts within the ontology.

If a particular token within the natural language content 105 is ambiguous, the concepts assigned to other terms in the content 105 may be used to disambiguate the meaning (e.g., concept) of the term. In some embodiments, a spreading activation technique may be used to disambiguate the meaning of an ambiguous token. As used herein, disambiguation may refer to selecting and/or weighting one or more of a plurality of concepts that may be ascribed to a natural language token. For example, if a token may refer to one of three different concepts in an ontology, disambiguation may refer to selecting one of the three different concepts and/or applying respective weight to the concepts, wherein a concept weighting factor may indicate a likelihood and/or probability that the token refers to the particular concept.

In some embodiments, the concept extraction module 120 may be configured to output a set of selected concepts 125. The selected concepts 125 may represent one or more concepts relevant to the natural language content 105. As discussed above, in some embodiments, weights may be applied to the concepts within the set of selected concepts 125; the weights may be indicative of a likelihood and/or probability that the concept in the selected concepts 125 is relevant to the natural language content 105.

The FIG. 1 example shows a set of selected concepts 125 produced by the concept extraction module 120 for the natural language content 105 “raid kills bugs dead.” As shown in FIG. 1, the “Raid (insecticide)” concept has a weight of 0.5, the “Insect” concept has a weight of 0.473, and the Permethrin concept has a weight of 0.122. As discussed above, the selected concepts 125 may represent mappings between tokens in the natural language content 105 and concepts within the ontology 110. As such, selected concepts 125 may be used to provide an objective indication of the underlying conceptual meaning of the content 105. As will be discussed below, the conceptual meaning of the content (as embodied in the weighted concept 125 data structure) may then be used to perform various tasks, including, but not limited to: more effectively indexing and/or cataloging the natural language content 105, providing links to similar content (e.g., content that relates to a similar set of concepts), providing more effectively targeted advertising to those accessing the content 105, and so on.

The ontology 110 may comprise precompiled knowledge formatted to be suitable for automated processing. For example, the ontology 110 may be formatted in Web Ontology Language (OWL or OWL2), Resource Description Format (RDF), Resource Description Format Schema (RDFS), or the like.

The ontology 110 may be generated from one or more knowledge sources comprising concepts and relations between concepts. Such knowledge sources may include, but are not limited to: encyclopedias, dictionaries, networks, and the like. In some embodiments, the ontology 110 may comprise information obtained from a peer-reviewed, online encyclopedia, such as Wikipedia (en.wikipedia.org). Wikipedia may be used since it contains knowledge entered by broad segments of different users and is often validated by peer review.

In addition, the ontology 110 may include and/or be communicatively coupled to one or more disambiguation resources provided by some knowledge sources. A disambiguation resource may provide an association between potentially ambiguous concepts and/or natural language tokens. For example, a particular term or phrase in a knowledge source, such as Wikipedia, may correspond to multiple “pages” within the knowledge source. Each of the “pages” may represent a different possible meaning (e.g., concept) for the term. For example, the term “Raid” may be associated with multiple pages within the knowledge source, including: a page describing a “Redundant Array of Independent/Inexpensive Disks,” a page describing “RAID, a UK-based NGO which seeks to promote corporate accountability, fair investment and good governance,” a page on Raid® insecticide, a page describing a military raid, a page referring to a gaming raid, and so on. The set of pages within the knowledge source may be used to provide a limited set of potential concept matches for the corresponding and/or equivalent term or phrase (e.g., token) in the natural language content. The concept extraction module 120 may then be used to disambiguate the meaning of the token (e.g., select and/or provide an indication, such as a weight, of the probability that the token in the natural language content corresponds to a particular concept). The concept extractor module 120 selects concepts relevant to the natural language content 105 from among the concepts within the ontology 110.

In some embodiments, an ontology, such as the ontology 110 of FIG. 1, may be generated by crawling through the topics (e.g., concepts) listed in a particular knowledge source (e.g., Wikipedia or the like). As used herein, crawling may refer to using a web-based crawler program, a script, automated program (e.g., bot), or the like, to access content available on a network. One or more resources (e.g., webpages) available through the knowledge source may be represented within the ontology as a concept (e.g., as a vertex within a graph data structure). Edges (e.g., relationships between concepts) may be extracted by categorization information in the knowledge source, such as links between pages within the knowledge source, references to other pages, or the like. In addition, some knowledge sources (e.g., on-line encyclopedias, such as Wikipedia) may comprise links to related material. Accordingly, in some embodiments, an edge may be created for each link within a particular concept (e.g., concept webpage), resulting in a complete set of concept relationships.

In some embodiments, an ontology, such as the ontology 110 of FIG. 1, may comprise information acquired from a plurality of different knowledge stores. Certain knowledge sources may be directed to particular topics. For example, an online medical dictionary may include a different set of concepts than a general-purpose encyclopedia. An ontology may be configured to gather conceptual information from both sources and may be configured to combine the different sets of information into a single ontology structure (e.g., a single ontology graph) and/or may be configured to maintain separate ontology structures (e.g., one for each knowledge source).

In some embodiments, differences between various knowledge stores may be used in a disambiguation process (discussed below). For example, a first knowledge source may include a relationship between a particular set of concepts (e.g., may link the concepts together) that does not exist in a second knowledge source. In some embodiments, the ontology may be configured to apply a weaker relationship between the concepts due to the difference between the knowledge sources. Alternatively, if a particular relationship between concepts exists within many different knowledge sources, the edge connecting the concepts may be strengthened (e.g., given a greater weight).

In some embodiments, the ontology, such as the ontology 110 of FIG. 1, may be adaptive, such that relationships between concepts may be modified (e.g., strengthened, weakened, created, and/or removed) responsive to machine learning techniques and/or feedback. Similarly, an ontology may be constantly updated to reflect changes to the knowledge sources upon which the ontology is based.

As discussed above, the ontology 110 of FIG. 1 may comprise a computer-readable storage medium, such as a disc, flash memory, optical media, or the like. In addition, the ontology 110 may be implemented in conjunction with a computing device, such as a server, configured to make ontological information available to other modules and/or devices (e.g., over a communications network). The ontology 110 may be stored in any data storage system known in the art including, but not limited to: a dedicated ontology store (e.g., Allegro® or the like); a database (e.g., a Structured Query Language (SQL) database, eXtensible Markup Language (XML) database, or the like); a directory (e.g., an X.509 directory, Lightweight Directory Access Protocol (LDAP) directory, or the like); a file system; a memory; a memory-mapped file; or the like.

In some embodiments, the ontology 110 may comprise a data access layer, such as an application-programming interface (API). The data access layer provide for access to the ontological information stored on the ontology 110, may provide for modification and/or manipulation of the ontology 110, may provide for interaction with the ontology 110 (e.g., using a language, such as Semantic Application Design Language (SADL)), or the like.

As discussed above, the ontology 110 may change over time responsive to knowledge input into the ontology 110 and/or feedback received by users of the ontology (e.g., the concept extractor module 120). In addition, the ontology 110 may be modified responsive to updates to the one or more knowledge sources used to generate the ontology 110. As such, the ontology 110 may comprise an updating mechanism (e.g., crawlers, scripts, or the like) to monitor the one or more knowledge sources underlying the ontology 110 and to update the ontology 110 responsive to changes detected in the respective knowledge sources.

The concept extraction module 120 may access the knowledge stored in the ontology to extract concepts from the natural language content 105 using one or more machine learning techniques. The concept extraction module 120 may be configured to disambiguate “ambiguous” tokens in the natural language content 105 (e.g., tokens that may refer to two or more concepts). The concept extraction module 120 may use a spreading activation technique to disambiguate ambiguous tokens. The spreading activation technique may leverage and/or interact with the ontology 110 to thereby generate disambiguation information.

In some embodiments, the spreading activation technique used by the concept extraction module 120 may access the ontology 110 in graph form, in which concepts may be represented as vertices and the associations (e.g., relationships) between concepts may be represented as edges. Each vertex (e.g., concept) may be assigned an activation value. For efficiency, the activations may be stored in a sparse graph representation, since at any point most vertices will have an activation value of zero.

The sparse ontology graph may be stored in a data structure, such as a memory-mapped file, which may permit on-demand loading and unloading of ontology data that may be too large to fit into physical memory. The data structure may be configured to provide relatively fast edge access. However, although a memory-mapped file representation of the ontology graph and/or sparse ontology graph is discussed herein, the systems and methods of this disclosure could be implemented using any data storage and/or data management technique known in the art. As such, this disclosure should not be read as limited to any particular data storage and/or management technique.

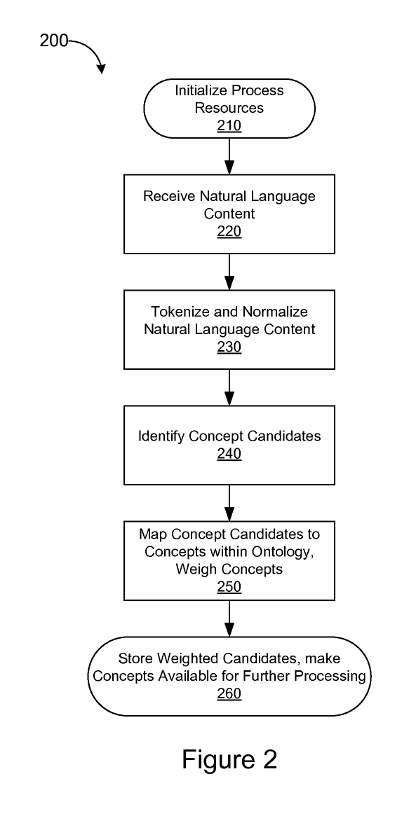

FIG. 2 is a flow diagram of one embodiment of a method for selected concepts relevant and/or related to natural language content. The method 200 may comprise one or more machine executable instructions stored on a computer-readable storage medium. The instructions may be configured to cause a machine, such as a computing device, to perform the method 200. In some embodiments, the instructions may be embodied as one or more distinct software modules on the storage medium. One or more of the instructions and/or steps of method 200 may interact with one or more hardware components, such as computer-readable storage media, communications interfaces, or the like. Accordingly, one or more of the steps of method 200 may be tied to particular machine components.

At step 210, the method 200 may be initialized (e.g., data structures and other resources required by the process 200 may be allocated, initialized, and so on). At step 220, natural language content may be received. As discussed above, the natural language content received at step 220 may be text content comprising any natural language content known in the art.

At step 230, the natural language content may be tokenized and/or normalized. The tokenization of step 230 may comprise a lexical analysis of the natural language content to identify individual words and/or phrases (e.g., tokens) therein. The resulting tokenized content may be represented as a sequence of recognizable words and/or phrases within a suitable data structure, such as a linked list or the like. Accordingly, the tokenization and normalization of step 230 may comprise parsing the natural language content into a sequence of tokens comprising individual words and/or phrases, normalizing the tokens (e.g., correcting unambiguous spelling errors and the like), and storing the tokenized data in a suitable data structure. The tokenization and normalization of step 230 may be further configured to remove punctuation and other marks from the natural language content, such that only words and/or phrases remain. Accordingly, step 230 may comprise a lexical analyzer generator, such as Flex, JLex, Quex, or the like.

At step 240, the tokenized natural language may be processed to identify one or more concept candidates therein. Natural language content may comprise one or more terms and/or phrases that may be used to determine and/or assign a set of concepts thereto. Other tokens may not provide significant information about the meaning of the content, but may act primarily as connectors between concepts (e.g., prepositions, “stopwords,” and the like). Selection of particular words and/or phrases from the tokenized natural language may be based on a number of factors including, but not limited to: whether the word or phrase represents a “stopword” (e.g., “the,” “a,” and so on), whether the word or phrase comprises a particular part of speech (POS) (e.g., whether the lexeme is a verb, subject, object, or the like), and the like.

In some embodiments, the logical structure of the content may be determined inter alia by the relationship of the stop words to the meaningful tokens. For example, the term “not” may not provide significant conceptual insight in the content, but may provide context to the concept following the term (e.g., not may indicate that the token following the “not” has a negative connotation within the content). Therefore, in some embodiments, information regarding the stopwords (or other structural elements) in the content may be retained to provide additional context to the concepts extracted from the other tokens.

At step 250, the tokens selected at step 240 may be associated with one or more concepts within an ontology. The one or more concepts associated with a token may be determined by a text-based comparison between each selected token and the contents of the ontology. As discussed above, an ontology may represent a collection of related concepts. Each concept may correspond to one or more text terms or phrases. In some cases, there may be a one-to-one correspondence between a particular concept and a token. For example, a vertex representing a “soccer” concept within the ontology may be directly matched to a “soccer” token. The “soccer” concept may be associated with other terms or phrases, such as “football,” “futebol,” or the like. The selection may be based upon the level of detail within the ontology. For example, in a less-detailed ontology, a “soccer” token may be matched to a “team sports” concept. In this case, the “team sports” concept may also be matched to a “baseball” token, a “basketball” token, and so on. Accordingly, the selection at step 250 may comprise one or more text comparisons, which may include comparing each token to a plurality of terms (e.g., tags) or other data associated with the concepts in the ontology.

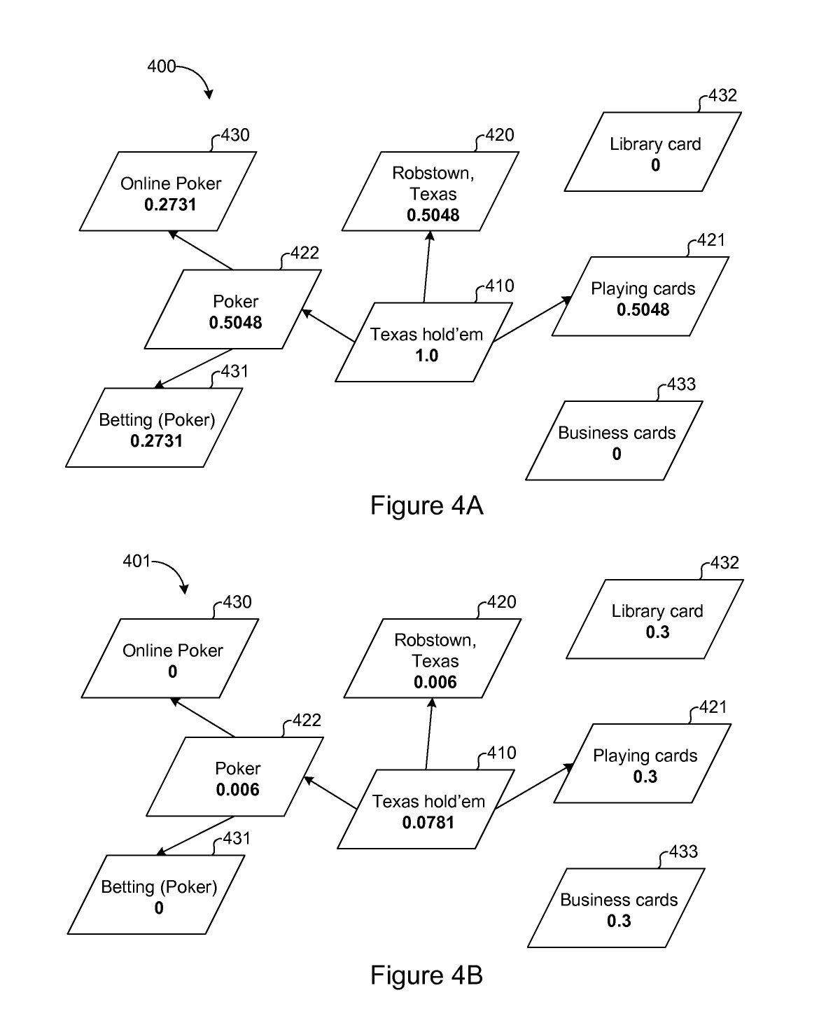

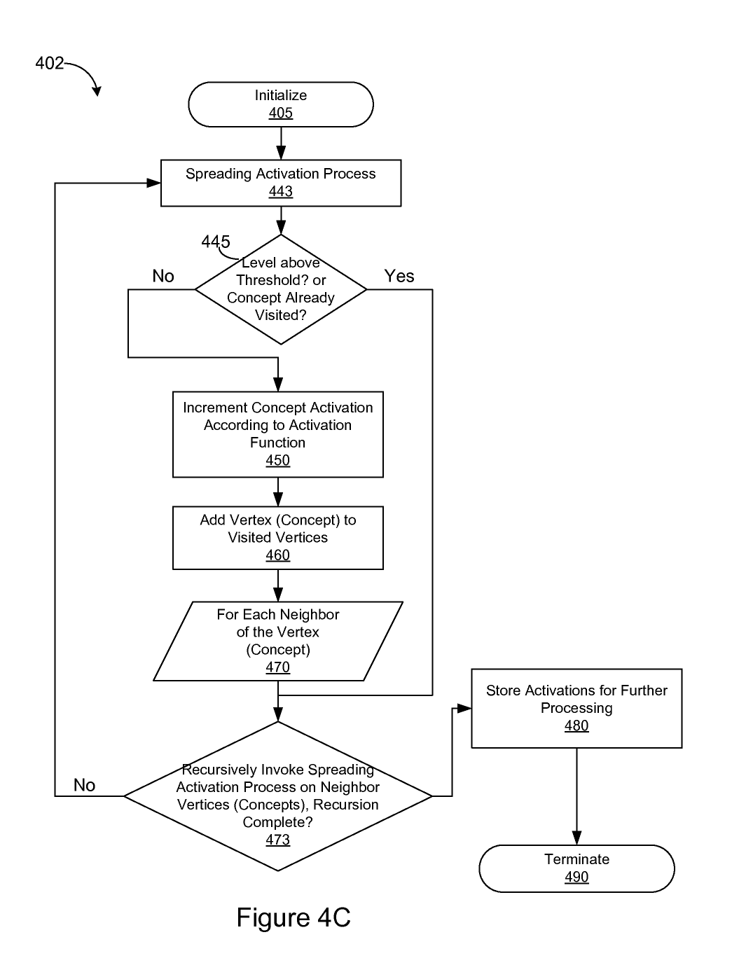

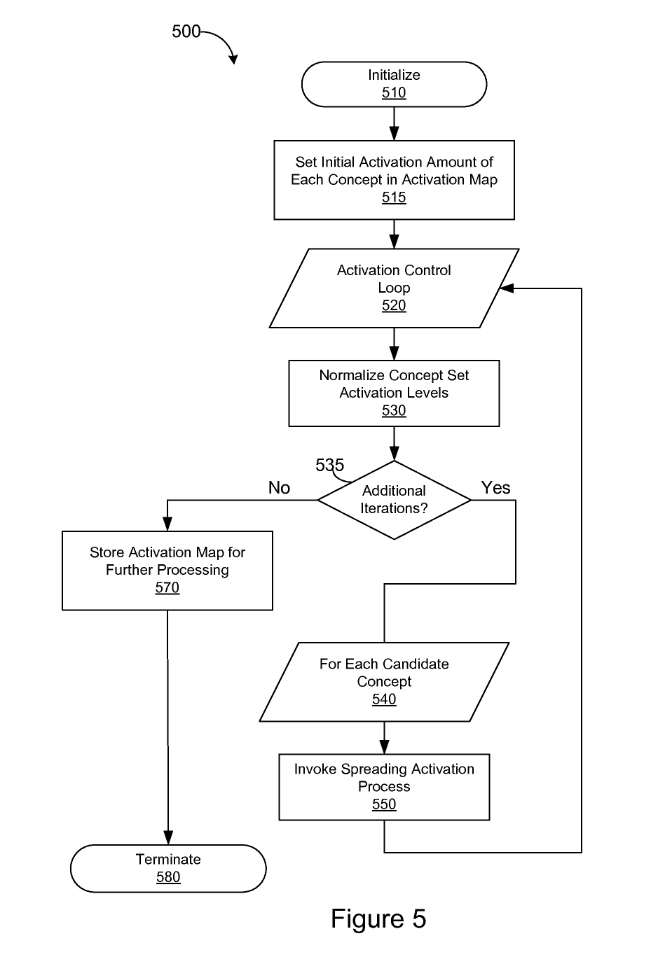

As discussed above, the concept that should be associated with a particular token may be ambiguous (e.g., the tokens may be associated with more than one concept). For example, and as discussed above, the “raid” term is capable of being associated with several different concepts (e.g., insecticide, an attack, and so on). Accordingly, the selection of step 250 may include selecting a plurality of concepts for a particular token. In some embodiments, each of the plurality of token-to-concept associations may comprise a weight. The weight of a particular token-to-concept association may be indicative of a likelihood and/or probability that the associated concept accurately represents the meaning the token is intended to convey in the natural language content. Accordingly, step 250 may further comprise the step of assigning a weight to each of the selected concepts. One embodiment of a method for assigning a weight to a concept-to-token association (e.g., a concept selection) using a spreading activation technique is described below in conjunction with FIGS. 4C and 5.

At step 260, the selected concepts may be stored for use in classifying the natural language content (e.g., the natural language content received at step 210). Storing at step 260 may include storing representations of the selected concepts in a computer-readable storage medium. The selected concepts may be linked and/or indexed to the natural language content received at step 220. For example, if the natural language content were a webpage, the selected concepts may be associated with the URI of the webpage. The selected concepts may be made available for various tasks, including, but not limited to: providing improved search performance to the natural language content, providing references to content similar to the natural language content received at step 220, providing contextual advertising, and the like.

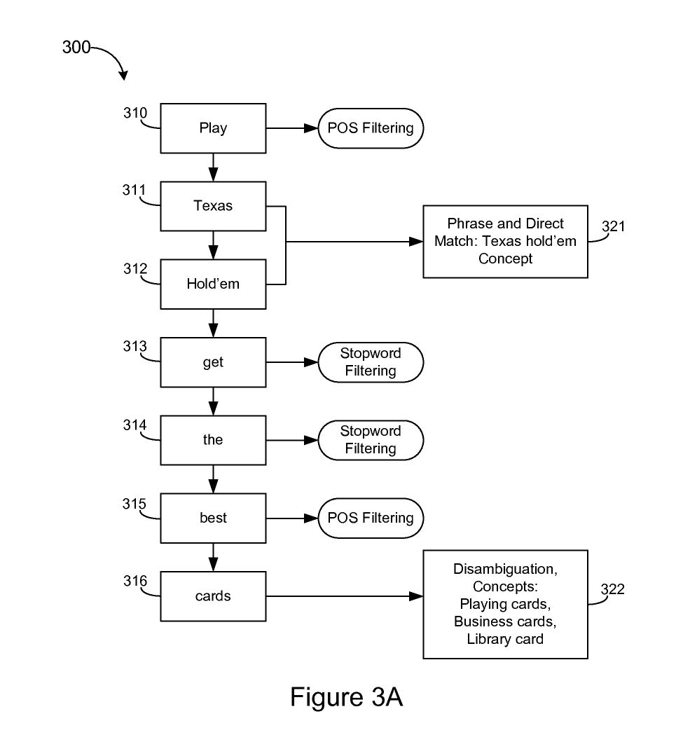

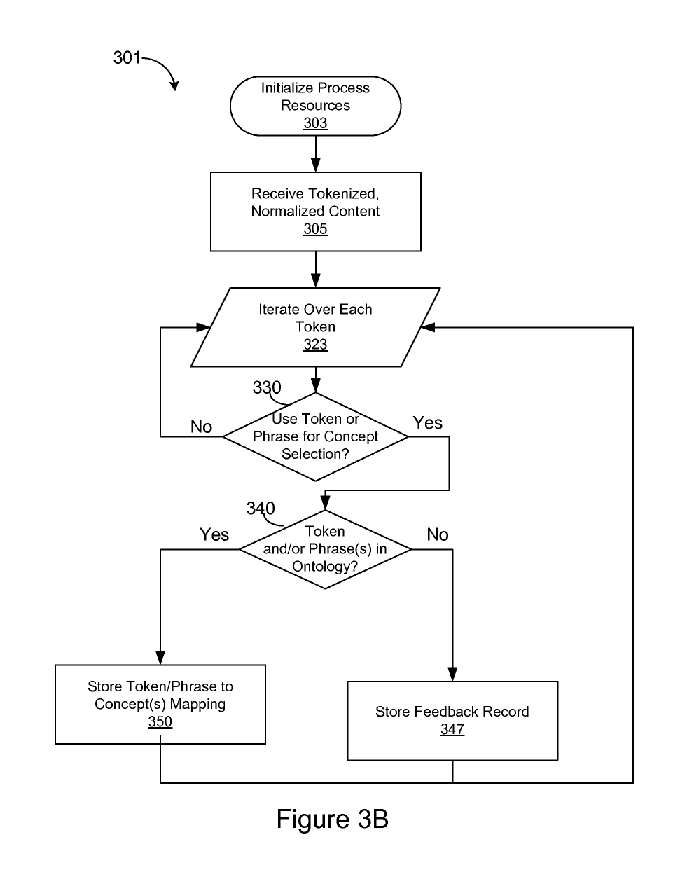

FIG. 3A is a data flow diagram illustrating a concept candidate identification process, such as the candidate identification step 240 described above in conjunction with FIG. 2. In FIG. 3A, the natural language content may comprise the following sentence, “Play Texas Hold'em get the best cards!” The natural language content depicted in FIG. 3A may have been tokenized into individual words (e.g., elements 310-316). In FIG. 3A, each of the tokens 310-316 may represent a single word within the natural language content.

As discussed above, one or more of the tokens (e.g., words) 310-316 parsed from the natural language content may be used to determine the conceptual meaning of the content (e.g., may be used to select concept candidates from an ontology). Not all of the tokens, however, may be effective at providing conceptual meaning. As discussed above, certain natural language elements, such as particular parts-of-speech (POS), “stopwords” (e.g., prepositions, pronouns, etc.), punctuation, and the like may not be effective at providing contextual meaning. Therefore, these types of tokens may not be selected for concept selection. The tokens to be used for concept selection may be determined based on various criteria, including, but not limited to: the part of speech of the token (e.g., whether the token is a known POS), whether the token is a structural element of the content (e.g., is a “stopword”), whether the token is found within an ontology (e.g., is associated with a concept in the ontology), whether the token is part of a phrase found within the ontology, or the like.

As discussed above, in some embodiments, certain natural language elements, such as certain parts of speech (POS), “stopwords,” punctuation, and the like may be retained in a separate data structure (not shown) to provide a structural relationship for concepts identified within the content. For example, an “and” part of speech may be used to create an association between two concepts in the content, a “not” term may be used to provide a negative connotation to one or more concepts within the content, and so on.

As shown in FIG. 3A, the tokens 310 and 315 may be identified as part-of-speech terms (e.g., token 310 is a verb and token 315 is an adjective) and, as such, may be removed from the concept selection process. The tokens 313 and 314 may be identified as stopwords and, as such, may be similarly filtered. The tokens 311, 312, and 316 may be used to identify a concept within the ontology.

After filtering, the remaining tokens (tokens 311, 312, and 316) may be mapped to respective concepts within an ontology. The mapping may include a text-based comparison between the tokens 311, 312, and/or 316, wherein a token (or a variation of the token) is compared against one or more terms associated with one or more concepts within the ontology. In some embodiments, the tokens may be modified to facilitate searching. For example, a search for concepts related to the “cards” token 316 may include the term “card” and/or “card*” where “*” is a wildcard character.

In some embodiments, adjoining tokens may be combined into another token (e.g., into a phrase comprising multiple tokens). For simplicity, as used herein, the term “token” may refer to a single term extracted from natural language content or multiple terms (e.g., a phrase). A phrase token may be used to match relevant concepts within the ontology. If no concepts are found for a particular phrase, the phrase may be split up, and the individual tokens may be used for concept selection. In some embodiments, even if a particular phrase is found in the ontology, concepts associated with the individual tokens may also be selected (and appropriately weighted, as will be described below).

In the FIG. 3A example, the tokens “Texas” 311 and “Hold'em” 312 may be combined into a phrase token and associated with a “Texas Hold'em” concept within the ontology. The associations or matches between tokens parsed from natural language content and an ontology may be unambiguous or ambiguous. An unambiguous selection may refer to a selection wherein a token is associated with only a single concept within the ontology. An ambiguous selection may refer to a selection wherein a token may be associated with a plurality of different concepts within the ontology.

In the FIG. 3A example, the “Texas Hold'em” token comprising tokens 311 and 312 is unambiguously associated with the Texas Hold'em card game concept 312. The cards token 316, however, may be an “ambiguous token,” which may potentially refer to a plurality of concepts 322 within the ontology (e.g., a “playing card” concept, a “business card” concept, a “library card” concept, and so on). The concept properly associated with an ambiguous token (e.g., token 316) may be informed by the other tokens within the content (e.g., tokens 311 and 312).

FIG. 3B is a flow diagram of one embodiment of a method 301 for identifying candidate tokens. The method 301 may be used to identify which tokens parsed from natural language content should be used for concept identification (e.g., should be used to identify candidate concepts for the natural language content). The method 301 may comprise one or more machine executable instructions stored on a computer-readable storage medium. The instructions may be configured to cause a machine, such as a computing device, to perform the method 301. In some embodiments, the instructions may be embodied as one or more distinct software modules on the storage medium. One or more of the instructions and/or steps of method 301 may interact with one or more hardware components, such as computer-readable storage media, communications interfaces, or the like. Accordingly, one or more of the steps of method 301 may be tied to particular machine components.

At step 303, the method 301 may be initialized, which may comprise allocating resources for the method 301 and/or initializing such resources. At step 305, a sequence of tokens may be received by the method 301. The tokens may have been obtained from natural language content (e.g., by parsing, tokenizing, and/or normalizing the content). The tokens may be represented in any data structure known in the art. In some embodiments, the tokens received at step 305 may comprise a linked list of tokens (or other relational data structure) to allow the method 301 to determine relationships between the tokens (e.g., to determine tokens that are approximate to other tokens within the original natural language content).

At step 323, the method 301 may iterate over each of the tokens received at step 305.

At step 330, an individual token may be evaluated to determine whether the token should be used for concept selection. The evaluation of step 330 may comprise detecting whether the token is a good concept selection candidate (e.g., based on whether the token is a part of speech, a stopword, or the like). If the token is not a viable candidate for concept selection, the flow may return to step 323 where the next token may be evaluated.

In some embodiments, the evaluation of step 330 may include evaluating one or more tokens that are proximate to the current token. The proximate token(s) may be used to construct a phrase token that includes the current token and the one or more proximate tokens. For example, a “Texas” token may be combined with a proximate “Hold'em” token to create a “Texas Hold'em” token. Similarly, the proximate tokens, “New,” “York,” and “Giants” may be combined into a single “New York Giants” token. If the phrase token(s), are determined to be viable for candidate concept selection, the flow may continue to step 340; otherwise, the flow may return to step 323, where the next token may be processed.

At step 340, the one or more tokens, may be used to identify one or more candidate concepts within an ontology. As discussed above, an ontology may represent a plurality of interrelated concepts as vertices within a graph structure. The relationships between concepts may be represented within the ontology data structure as edges interconnecting the vertices. At step 340, the method 301 may determine whether the current token may be associated with one or more concepts within the ontology (e.g., using a text-based comparison, or other matching technique).

In some embodiments, variations of the token may be used. For example, a token comprising the term “cards” may be modified to include “card,” “card*,” or other similar terms. This may allow the token to map to a concept, even if the precise terminology is not the same (e.g., may account for tense, possessive use of the term, plural form of the term, and so on). The one or more phrases (if any) comprising the token may be similarly modified.

In some embodiments, the method 301 may search the ontology using phrase tokens before searching the ontology using the individual token. This approach may be used since a phrase may be capable of identifying a more precise and/or accurate concept association than a single term. In the “Texas Hold'em” example, the concept associated with the “Texas Hold'em” phrase (e.g., the Texas Hold'em card game concept) provides a more accurate reflection of the actual meaning of the natural language content than would either the “Texas” token and/or the “Hold'em” token separately.

If one or more concepts associated with the token are identified within the ontology, the flow may continue to step 350; otherwise, if the token (or token phrases) are not found within the ontology, the flow may continue to step 347.

At step 347, a feedback record indicating that the method 301 was unable to associate the token with any concepts in the ontology may be generated and stored. The feedback may be used to augment the ontology. For example, if a particular token appears in several examples of natural text content, but a concept associated with the token cannot be found in the ontology, the ontology may be modified and/or augmented to include an appropriate association. This may include modifying an existing concept within the ontology, adding one or more new concepts to the ontology, or the like.

At step 350, a mapping between the particular token and the one or more concepts may be stored in a data structure on a computer-readable storage medium. In some embodiments, the data structure may comprise a portion of the ontology (e.g., a copy of the ontology, a sparse graph, or the like) comprising the one or more concepts associated with the token. The data structure comprising the mappings may be used to assign and/or weigh one or more concepts associated with the natural language content. In some embodiments, the data structure may comprise an activation map.

As used herein, an “activation map” may refer to an ontology, a portion of an ontology (e.g., a sparse ontology), a separate data structure, or other data structure capable of representing activation values and/or concept relationships. In some embodiments, an activation map may be similar to an ontology data structure, and may represent the concepts identified at steps 323, 330, and 340 as vertices. The vertices may be interconnected by edges, which, as discussed above, may represent relationships between concepts. Accordingly, an activation map may include portions of an ontology (e.g., may be implemented as a sparse ontology graph). One example of an activation map is discussed below in conjunction with FIGS. 4A and 4B.

Following steps 350 and/or 347, the flow may return to step 323 where the next token may be processed. After all of the tokens have been processed, the flow may terminate.

The outputs of the concept candidate identification process (e.g., process 301 of FIG. 3B) may flow to a concept selection process, which may assign relative weights to the concepts identified in the method 301. In some embodiments, a spreading activation technique may be used to apply respective weights to the concepts. The spreading activation technique may include a recursive and iterative procedure, in which, given a particular concept and activation amount, the procedure tags other concepts within the activation map with activation amounts based on their respective similarity to the activated concept. Accordingly, concepts that are similar to the activated concept will tend to have higher activation values than dissimilar concepts. The similarity of a particular concept to an activated concept may be determined based on relationships within the activation map, which, as discussed above, may comprise links (e.g., edges) connecting related concept vertices. Accordingly, the weights assigned to the concepts may be based upon the other concepts within the natural language content (e.g., based on the context of the natural language content).

FIG. 4A is a data flow diagram depicting a portion of an activated ontology graph. The activation map 400 of FIG. 4A may comprise a plurality of interconnected vertices. The vertices may represent concepts identified within natural language content (e.g., using a method, such as method 301) and/or concepts related to the identified concepts (e.g., concepts within one or two edges of the identified concepts). Relationships between concepts (e.g., the edges of the activation map 400) may be determined by the ontology. Accordingly, the activation map 400 may comprise a portion of an ontology graph (e.g., a sparse representation of the ontology graph).

Each concept within the activation map (each vertex 410, 420, 421, 422, 430, 431, 432, and 433) may be assigned a respective activation value. The activation value of the vertices may be determined using a spreading activation technique. One example of a method for implementing a spreading activation technique is discussed below in conjunction with FIG. 4C.

The spreading activation technique may comprise initializing the activation values of the vertices in the activation map 400. Concepts that were unambiguously identified may be given an initial activation value of one, and concepts within competing sets of concepts may be initialized to a reduced activation value (e.g., one over the number of candidate concepts identified).

The spreading activation process may iteratively spread the initial activation values to nearby, related concepts within the ontology graph. The activation amount “spread” to neighboring vertices may be calculated using a stepwise neighborhood function (e.g., Equation 1 discussed below). However, other activation functions and/or function types could be used under the teachings of this disclosure including, but not limited to logarithmic neighborhood functions, functions related to the number neighbors of a particular vertex, and the like.

As discussed above, concepts that can be clearly identified in the natural language content (e.g., concepts unambiguously selected by one or more tokens or phrases in process 301) may be initialized at an activation of one. Other tokens extracted from the natural language content may be associated with two or more different concepts (e.g., the meaning of the token or phrase may be ambiguous). Ambiguous concepts may be assigned a different initial activation value. In some embodiments, the activation value assigned to a set of ambiguous concepts may be normalized to one (e.g., each concept is initialized to one divided by the number of ambiguous concepts associated with the token or phrase).

After initialization, the spreading activation technique may “spread” the initial activation values to neighboring concepts. The amount of spreading during a particular iteration may be based upon the activation value of the neighboring concept, the nature of the relationship between the neighboring concepts (e.g., the edge connecting the concepts), the proximity of the concepts in the ontology graph, and the like. In some embodiments, the spreading activation technique may use a spreading activation function to calculate the activation amount to be “spread” to neighboring vertices. In some embodiments, a stepwise neighborhood activation function, such as the function shown in Equation 1, may be used:

$${W}_{n} = \frac{0.7 \cdot {W}_{P}}{log ( 1 + N )} \qquad Eq . 1$$

In Equation 1, W_{N} may represent the activation value applied to the neighbors of a particular vertex, W_{P} may represent the activation amount of the particular vertex (the concept from which the activation values are spread to the neighbors), and N may be the number of neighbors of the particular vertex in the ontology. Accordingly, the value spread to the neighboring vertices may be determined by the initial activation value of the vertex, the number of neighboring vertices, and a constant decay factor (e.g., 0.7 in Equation 1). Various different spreading functions and/or decay factors could be used under various embodiments.

In some embodiments, activation amounts may be applied to increasingly remote neighbors according to the stepwise function of Equation 1. In the FIG. 4A embodiment, the activation values may be spread to only those concepts within a predetermined number of generations. For example, only the second generation of related nodes may be activated (e.g., activation may “spread” only as far as within two generations of a particular concept). However, in other embodiments, the activation spreading may be allowed to go deeper within the activation map.

Given the nature of the spreading activation process, concepts that are more closely related to a concept having a relatively high activation value may have their respective activation value increased. In addition, according to Equation 1, activation amounts may be spread more thinly across nodes having more neighbor concepts than those nodes having only a few, closely related neighbor concepts. Concepts that are relatively close together (e.g., are interrelated within the ontology) may be cross-activated by one another. Accordingly, other concepts identified within the natural language content (either ambiguously or unambiguously) may spread their activation values to other related concepts in the ontology.

An iteration of the activation spreading process described above may comprise iterating over each vertex within the activation map and, for each vertex, spreading the activation value of the vertex to its neighbors. Following each iteration, the activation values of the vertices in the activation map may be normalized. The spreading activation technique may be performed for a pre-determined number of iterations, until a particular activation value differential is reached, or the like.

FIG. 4A shows one embodiment of an activation map. As shown in FIG. 4A, the “Texas Hold'em” vertex 410 has an activation value of one, since the term, “Texas Hold'em” may be unambiguously associated with the “Texas Hold'em” concept 410. The vertex 410 may have three neighbor vertices, a “Robstown, Texas” vertex 420, a playing card vertex 421, and a poker vertex 422. During a first iteration of the spreading activation technique, each of the neighboring vertices 420, 421, and 422 may be assigned an activation value according to Equation 1.

In the FIG. 4A example, more remote neighbors may be activated according to Equation 1. For example, the neighbors of the “poker” vertex 422 (the “online poker” vertex 430 and the “betting (poker)” vertex 431) may be activated. However, as shown in FIG. 4A, the activation amounts of these more remote vertices are significantly smaller than the activation amounts of the vertices more proximate to vertex 410.

Since the “library card” vertex 432 and the “business cards” vertex 433 are not related to the activated “Texas Hold'em” vertex 410, neither is assigned an activation value. In addition, although not shown in FIG. 4A, more remote related concepts (e.g., concepts related to the “online poker” vertex 430 or the like), may not be activated (e.g., the spreading activation process may limit the “depth” traversed within the ontology graph to a threshold value such as two edges).

The spreading activation technique may work similarly for sets of candidate concepts (e.g., where a token or phrase maps to a plurality of concepts), except that each concept is considered to be “competing” with the others for dominance. This competition may be represented by rescaling the activation value for all of the concepts within a competing set to 1.0 (normalizing the activation values). As such, if there are three competing concepts within a particular set, each concept may be initialized to an activation value of ⅓. Similarly, the spreading activation values applied to such concepts may be scaled by the same multiplier (e.g., ⅓). This forces ambiguous concepts (e.g., concepts mapped using a general term, such as “card”) to have a lower influence of the solution than concepts that have a clear, unambiguous meaning (e.g., the “Texas Hold'em” concept discussed above). The lower activation amounts applied to ambiguous concepts (e.g., where a token or phrase was ambiguously associated with two or more concepts within the ontology) may reflect the lack of confidence in which of the concepts represents an actual meaning conveyed by the particular token or phrase in the natural language content.

FIG. 4B shows another example of a spreading activation data flow diagram of an activation map associated with the term “card” (e.g., from the example natural language text “Play Texas Hold'em get the best cards”). As discussed above, the term “card” may be associated with a plurality of different concepts within the ontology. Accordingly, the “card” term may result in an “ambiguous” concept mapping. As shown in FIG. 4B, each of the candidate concepts associated with the card term (the “business cards” vertex 433, the “playing cards” vertex 421, and the “library card” vertex 432) may be initialized with an activation value of approximately ⅓ (e.g., 0.3). The activation value of each of the activated vertices may flow to neighboring vertices as described above. The activation values assigned to each of the vertices 432, 421, and 433 may flow to other vertices within the ontology graph as described above.

FIG. 4C is a flow diagram of a method 402 for spreading activation values within an activation map and/or ontology graph, such as the activation maps 400 and 401 described above. The method 402 may comprise one or more machine executable instructions stored on a computer-readable storage medium. The instructions may be configured to cause a machine, such as a computing device, to perform the method 402. In some embodiments, the instructions may be embodied as one or more distinct software modules on the storage medium. One or more of the instructions and/or steps of method 402 may interact with one or more hardware components, such as computer-readable storage media, communications interfaces, or the like. Accordingly, one or more of the steps of method 402 may be tied to particular machine components.

At step 405, resources for the method 402 may be allocated and/or initialized. The initialization of step 405 may comprise accessing an activation map and/or ontology graph comprising one or more concept candidate vertices. In some embodiments, the initialization may comprise determining a subgraph (or sparse graph) of the ontology comprising only those vertices within a threshold proximity to the candidate concept vertices. This may allow the method 402 to operate on a smaller data set. In other embodiments, the initialization may comprise initializing a data structure comprising references to vertices within the ontology graph, wherein each reference comprises an activation value. In this embodiment, the activation map may be linked to the ontology and, as such, may not be required to copy data from the ontology graph structure.

At step 440, a recursive spreading activation process may be performed on an activated concept within the graph. The activation values spread by the selected concept may be used to disambiguate competing concepts within the graph. For instance, in the FIGS. 4A and 4B examples, the activation values generated by performing the spreading activation method 402 on the “Texas Hold'em” concept (element 410 in FIG. 4A) may be used to disambiguate between the set of candidate concepts associated with “cards” token in the natural language content (e.g., disambiguate between the “library card” concept 432, “business cards” 433 concept, and “playing cards” concept 421).

The method 402 is described as operating on a single activated concept. Accordingly, the method 402 may be used by another process (e.g., an activation control process, such as method 500 described below in conjunction with FIG. 5) to perform spreading activation on each of a plurality of candidate concepts identified within a particular set of natural language content.

In some embodiments, the spreading activation steps 440-473 may be performed for a pre-determined number of iterations and/or until certain criteria are met (e.g., when concepts have been sufficiently disambiguated). For example, the steps 440-470 may be performed until ambiguity between competing concepts has been resolved (e.g., until a sufficient activation differential between competing concepts has been achieved, until an optimal differential has been reached, or the like).

The spreading activation of step 440 may be recursive and, as such the spreading activation of step 440 may comprise maintaining state information, which may include, but is not limited: a current vertex identifier (e.g., an identifier of the vertex on which the spreading activation step 440 is operating), a current activation value, a level (e.g., generational distance from the activated “parent” vertex and the current vertex), a reference to the ontology graph, current activations (e.g., a data structure comprising references to vertices within the ontology graph and respective activation values), a set of vertices that have already been visited (e.g., to prevent visiting a particular vertex twice due to loops within the ontology graph), and the like.

For a top-level activated node, the recursive spreading activation process of step 440 may be invoked using an identifier of the activated node, an appropriate activation value (e.g., 1.0 if the vertex was unambiguously identified, or a smaller amount based on the size of the candidate set), a level value of zero, a reference to the graph (e.g., activation map, ontology graph, subgraph, or the like), a set of current activations, and an empty set of visited vertices.

Steps 445-473 may be performed within the recursive spreading activation process 440. At step 445, the spreading activation function may determine whether the current level (e.g., generational distance from the node that initially invoked the spreading activation process) is larger than a threshold value. As discussed above, in some embodiments, this threshold level may be set to be two. Accordingly, an activation value may be spread from an activated vertex to vertices within two edges of the activated vertex. If the vertex is more than two (or other threshold value) edges from the activated, parent vertex, the vertex may be skipped (e.g., the flow may continue to step 473). In some embodiments, the method 402 may also determine whether the spreading activation process has already visited the current vertex. This determination may comprise comparing an identifier of the current vertex to the set of visited vertices discussed above. A match may indicate that the vertex has already been visited. If the vertex has already been visited (e.g., by another pathway in the graph), the vertex may be skipped. In the FIG. 4C example, if the level is greater than two and/or the vertex has already been visited, the flow may continue to step 473, where the next node in the recursion may be proceed; otherwise, the flow may continue to step 450.

At step 450, the activation amount of the current vertex may be incremented by the activation amount determined by an activation function. The activation function of step 450 may comprise a stepwise activation function, such as the stepwise activation function of Equation 1 discussed above.

At step 460, the current vertex may be added to the set of visited vertices.

At step 470, the method 402 may recursively iterate over each neighbor of the current vertex (e.g., vertices directly connected to the current vertex in the ontology graph). The iteration may comprise performing steps 445-470 on each neighbor vertex.

At step 473, the spreading activation process of step 440 may be invoked for each of the neighbor vertices iterated at step 470. The recursive calls may comprise parameters to allow the spreading activation process (e.g., step 440) to maintain the state of the method 402. As such, the recursive call may comprise passing parameters including, but not limited to: a node identifier of the neighbor vertex to be processed, an activation amount for the neighbor vertex (e.g., calculated using an activation value decay function, such as Equation 1), a level of the neighbor (e.g., the current level plus one (1)); a reference to the ontology graph, the set of current activations, and the set of visited vertices. The recursive call returns the flow to step 440 (with a different set of parameters). Each recursive call to the spreading activation process (e.g., step 440) may cause the method 402 to spread activation values within the ontology until a level threshold and/or loop within the ontology is reached.

Recursively iterating the neighbor vertices at step 473 may comprise performing step 440-473 for each neighbor vertex. Accordingly, for each vertex, the flow may continue at step 440. After each neighbor has been processed (no more neighbor vertices remain), the flow may continue to step 480.

At step 480, the graph (including the activation values established by iterating over steps 440-473) may be made available for further processing. Accordingly, step 480 may include storing the graph and/or activation values on a computer-readable storage medium accessible to a computing device. At step 490, the method 402 may terminate.

The spreading activation process 402 of FIG. 4C may be used to perform spreading activation for a single activated concept within an activation map. For example, the method 402 may be used to generate the activation maps 400 and/or 401 described above in conjunction with FIGS. 4A and 4B. The method 402 may be used as part of a control activation process configured to perform a spreading activation function for each of a plurality of candidate concepts identified in a particular set of natural language content. The control activation process may be adapted to disambiguate between competing concepts within one or more concept sets (e.g., determine which concept within a particular set of concepts a particular token and/or phrase refers). As discussed above, the spreading activation values of unambiguous concepts may be used in this disambiguation process. This is because the activation value of particular concepts within a set of concepts may be incremented by other concept mappings.

For example, as discussed above, some concepts may be unambiguously identified from the natural language content (e.g., an unambiguous concept). The “Texas Hold'em” concept from FIGS. 4A and 4B is an example of an unambiguous concept. The activation spreading information provided by these unambiguous concepts may be used to disambiguate and/or identify other concepts within the natural language content. As shown in FIGS. 4A and 4B, the unambiguous “Texas Hold'em” concept 410 may cause the activation of the “playing card” concept 421 to be increased. Accordingly, if the dataflow maps of FIGS. 4A and 4B were to be combined and/or if the spreading activation process of FIGS. 4A and 4B were performed on the same graph (activation map or ontology graph), the activation value of the “playing cards” vertex 421 would be 0.8049 (0.3 for the original activation value plus 0.5049 according to the spreading activation of the “Texas Hold'em” vertex 410). Therefore, the activation value of the “playing cards” concept may be increased, which may allow the “cards” term within the natural language content to be disambiguated from its other possible meanings (e.g., the “library card” concept and the “business cards” concept). Similarly, spreading activation of related concept sets may be used to provide disambiguation information to one another.

FIG. 5 is a flow diagram of one embodiment of an activation control method 500. The activation control method 500 may perform a spreading activation function (such as the spreading activation method 402 of FIG. 4C) over each of the concepts and/or candidate sets identified in a particular portion of natural language content (e.g., concepts of candidate sets identified using method 301 of FIG. 3B). The method 500 may comprise one or more machine executable instructions stored on a computer-readable storage medium. The instructions may be configured to cause a machine, such as a computing device, to perform the method 500. In some embodiments, the instructions may be embodied as one or more distinct software modules on the storage medium. One or more of the instructions and/or steps of method 500 may interact with one or more hardware components, such as computer-readable storage media, communications interfaces, or the like. Accordingly, one or more of the steps of method 500 may be tied to particular machine components.

At step 510, the activation control method 500 may allocate and/or initialize resources. As discussed above, this may comprise accessing an ontology graph, allocating data structures for storing activation information (e.g., references to vertices within the ontology and associated activation values), accessing a set of candidate concepts identified from a set of natural language content, and the like. The initialization may further comprise setting the activation value for each of the vertices to zero and/or setting any iteration counters to zero.

At step 515, the activation value of each of the identified concepts and/or concept sets may be set to an initial activation level. As discussed above, concepts that were unambiguously identified may be set to an activation value of one. For example, the “Texas Hold'em” concept 410 of FIG. 4A may be assigned an initial activation value of one at step 515. Concepts within sets of competing concepts may be assigned a smaller activation value. As discussed above, the initial activation value may be normalized to one. Accordingly, the activation value may be set according to Equation 2 below:

$${A}_{c} = \frac{1}{{N}_{c}} \qquad Eq . 2$$

In Equation 2, the activation value of a concept within a set of competing concepts (A_{C}) is one divided by the number of competing concepts within set (N_{C}). Therefore, in FIG. 4B, the three competing concepts for the “cards” token (e.g., “library card” concept 432, “playing cards” concept 421, and the “business cards” concept 433) may be set to an initial activation value of ⅓.

At step 520, the method may enter a control loop. The control loop of step 520 may cause the steps within the control loop (e.g., steps 530-550) to be performed until an iteration criteria is met. As will be discussed below, successive iterations of the control loop comprising steps 530-550 may allow the method 500 to propagate the effects of the activation spreading process throughout the graph (activation map or ontology). For instance, each time the control loop of step 520 is processed, the results of the activation spreading process may become more pronounced; concepts that are closely related to “strong” concepts (e.g., concepts having a relatively high activation value) may have their activation value increased to a greater degree than other concepts, which may be more remote from the “strong concepts.” The divergence between the “strong” concepts and “weaker” concepts (e.g., concepts having a relatively lower activation value) may increase as the number of iterations of the control loop increases. In addition, multiple iterations over the control loop of step 520 may allow the effect of the “strong” concepts to propitiate throughout the ontology (e.g., beyond the two level limit discussed above in conjunction with FIG. 4C).

The number of iterations of the control loop 520 may vary according to a ratio of “strong” concepts to “weak” concepts, the complexity of concept relationship, and the like. In the FIG. 5 embodiment, an iteration limit of three may be used. Accordingly, the control loop comprising steps 530-550 may be performed three times. However, the method 500 could be configured to continue iterating until another criteria is met (e.g., may iterate until a threshold activation differential is established between candidate concepts, until an optical differential is reached, or the like).

At step 530, the process may iterate over each of the concept sets within the activation map. For each concept set, the activation values of the concept sets may be normalized to one. This may prevent concepts sets for which there is no “consensus” (e.g., no one concept within the concept set has an activation value significantly greater than the competing concepts) from unduly influencing other concepts in the graph. Accordingly, the activation value of each concept set may be normalized according to Equation 3 below:

$${A}_{i} = \frac{{A}_{i - 1}}{{\sum }_{n = 1}^{N} {A}_{n - 1}} \qquad Eq . 3$$

In Equation 3, Aᵢ may represent the normalized activation value set at step 530 for use in the current iteration of the control loop; Aᵢ₋₁ may represent the activation value calculated by a previous iteration of the spreading activation process (the operation of one embodiment of a spreading activation process is discussed below). Equation 3 calculates the normalized activation value (A) as the previous activation value (Aᵢ₋₁) divided by a sum of the previous activation values (Aₙ₋₁) of the other N members of the candidate concept set (e.g., the activation values calculated for the respective candidate concepts during the previous iteration of the spreading activation process). Accordingly, after normalization, the activation value for each of the candidate concepts within a particular concept set will sum to one.

At step 535, the method 500 may determine whether the control loop has been performed a threshold number of times (e.g., three times) and/or whether other completion criteria has been satisfied (e.g., there is at least a threshold differential between activation values of completing concepts, an “optimal” differential has been reached, or the like). If the completion criteria is satisfied, the flow may continue to step 570; otherwise, the flow may continue to step 540.

At step 540, the method 500 may iterate over each concept and/or candidate concept identified with the natural language content. The concepts iterated at step 540 include those concepts that were unambiguously identified (e.g., “Texas Hold'em” concept discussed above) and competing concepts within concept sets.

At step 550, a recursive spreading activation process may be performed on each concept. The spreading activation process of step 550 may comprise the spreading activation method 402 of FIG. 4C. As discussed above, the spreading activation process of step 550 may allow “stronger” concepts (e.g., concepts having a higher activation value) to disambiguate competing concepts. In the activation function of 540, closely related concepts reinforce one another, leading to higher relative activation values for such concepts.

After invoking the spreading activation process of step 550 for each of the candidate concepts, the flow may return to step 530.

After the completion criteria of step 535 has been satisfied (e.g., after steps 530-550 have been iterated three times), at step 570, the activation map comprising the relevant (e.g., activated) vertices of the ontology graph and their respective activation values may be stored for further processing and/or use in classifying the natural language content. In some embodiments, step 570 may comprise selecting one or more concepts from the graph for storage. The select concepts may be those concepts that are determined to accurately reflect the conceptual meaning of the natural language content. In some embodiments, only the selected concepts may be stored. The selection of the concepts may be based on various criteria. For instance, the selection may be based on the activation value of the concepts in the graph (e.g., concepts that have an activation value above a particular activation threshold may be selected). However, other selection criteria may be used. For example, the selection of one or more of a plurality of completing concepts may be based upon a difference between activation values of the competing concepts, proximity of the competing concepts to other, selected concepts (e.g., unambiguous concepts, selected ambiguous concepts, or the like), a comparison to an activation threshold, or other factors. The selected concepts and/or the associated activation values may be stored in a computer-readable storage medium and made available to other processes and/or systems. The selected concepts may be used to, inter alia, classify and/or index the natural language content, select other content that is conceptually similar to the natural language content, select context-sensitive advertising, or the like.

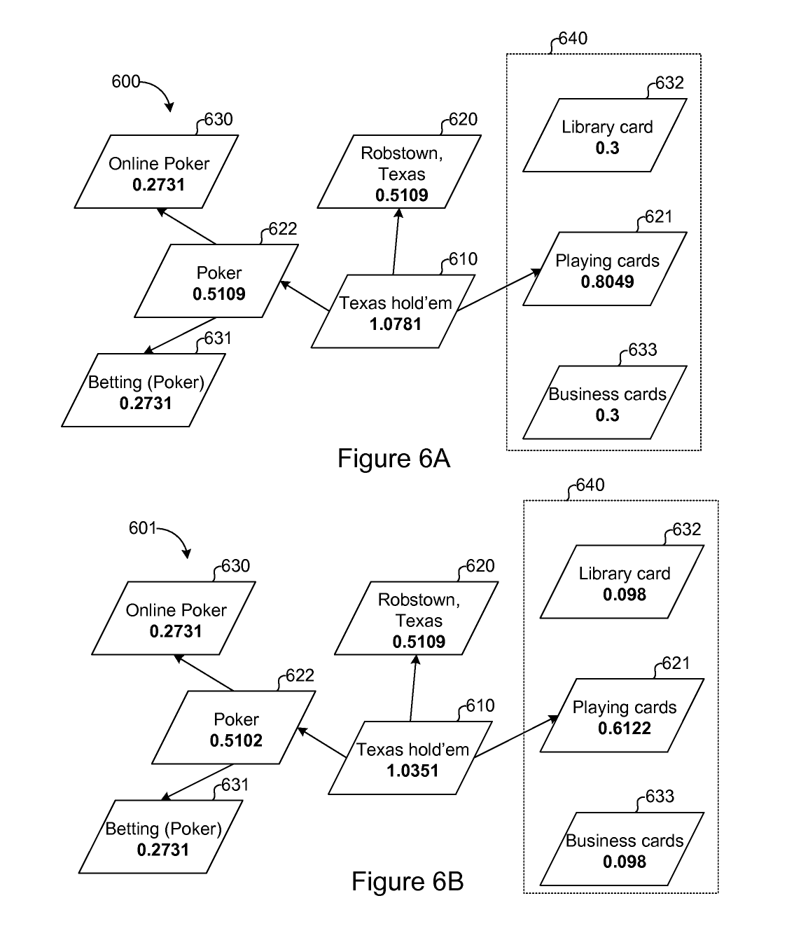

FIG. 6A shows a data flow diagram 600 of concepts associated with the natural language content “Play Texas Hold'em get the best cards!” discussed above. The dataflow diagram 600 of the FIG. 6A shows exemplary activation values after a single iteration of a spreading activation process is performed on the candidate contents (e.g., using the spreading activation method 500 of FIG. 5). The edges between the concepts shown in FIG. 6A may be defined in an ontology and, as such, may correspond to relationships between similar concepts.

As discussed above, the term “cards” in the natural language content maps to a set of competing concepts 640 comprising a “library card” concept 632, a “playing cards” concept 621, and a “business cards” concept 633. However, as shown in FIG. 6, the spreading activation of the “Texas Hold'em” concept 610 increases the activation value of the “playing cards” concept 621 relative to the other competing concepts in the set 640 (concepts 632 and 633).

The FIG. 6A example shows the results of an iteration over each of the candidate concepts in an activation map. Therefore, FIG. 6A may correspond to a combination of the data flow diagrams 400 and 401 depicted in FIGS. 4A and 4B respectively. The activation value of the “Texas Hold'em” concept 610 reflects its initial activation value of one plus the incremental activation spread from the “playing cards” concept 621. Similarly, the activation value of the “playing cards” concept 621 reflects its initial activation value of 0.3 plus the incremental activation spread from the “Texas Hold'em” concept 610. Therefore, the activation value of both concepts 610 and 621 are increased relative to other, unassociated concepts in the graph (e.g., concepts 632, 633).

As discussed above, multiple iterations of the spreading activation process (e.g., method 402 of FIG. 4C and/or step 540 of FIG. 5) may be used to improve concept identification. For example, multiple iterations may allow the activation value of “strong” concepts to increase the activation of related concepts within sets of competing concepts (e.g., the “playing cards” concept 621 within concept set 640). Therefore, the differences in activation values between related and unrelated concepts may increase for each iteration, until an “optimal” difference is established.

Each iteration the spreading activation technique may include rescaling or normalizing the activation values of the concepts to one. This may prevent concepts with no clear “winner” from unduly influencing the other concepts in the candidate space.

FIG. 6B shows a data flow diagram 601 of the concept candidates after multiple iterations of the activation spreading process (e.g., multiple iterations of the control loop of 520 of FIG. 5). As shown in FIG. 6B, the activation value of the “playing cards” concept 621 is significantly higher than the other competing concepts within the set of competing concepts 640 (e.g., “library card” concept 632 and/or “business cards” concept 633).

The activation map comprising the references to the vertices (e.g., elements 610, 620, 621, 622, 631, 632, and 633) and their respective activation weights may be stored for further processing. Unambiguous concepts may have relatively high activation values (due to inter alia being initialized to one). Similarly, dominant concepts within certain concept sets (e.g., concept set 640) may converge to a relatively high activation value. In addition, concepts that are closely related to unambiguous and/or dominant concepts may similarly converge to a relatively high activation value (e.g., the “poker” concept 622) after a certain number of iterations.

In some embodiments, the activation map (e.g., the data structure 601) may flow to a concept selection process. The concept selection process may select concepts from the activation map that are considered to accurately represent concepts related to the natural language content. As discussed above, the selection may be based on various different criteria, such as the resulting activation values of each of the concepts in the activation map. In some embodiments, the selection may comprise comparing the activation value of the concepts in the activation map to a threshold. The concepts that have an activation value above the threshold value may be selected, and all others may be removed. The threshold value may be static (e.g., the same threshold value may be used for each concept within the activation map) or the threshold may be dynamic (e.g., a lower threshold may be applied to concepts within concept sets and/or closely related concepts). Other criteria may be used, such as distance metric (e.g., distance from other, selected and/or unambiguous concepts within the activation map, comparison between the start activation value to the end activation value, a derivative of one or more activation values, or the like).

The concepts that remain in the activation map may represent concepts relevant to the natural language content. For example, in the “Play Texas Hold'em get the best cards!” example, the concepts having the largest activation values include the “Texas Hold'em” concept 610, the “playing cards” concept 621, the “poker” concept 622, and the “Robston, Texas” concept 620. Depending upon the selection criteria used, the “online poker” concept 630 and/or the “betting (poker)” concepts 631 may also be considered to be relevant.

As discussed above, the concepts identified by the systems and methods discussed herein may be used for various purposes, including providing improved search and/or indexing capabilities into the natural language content. For example, the “Texas Hold'em” content may be returned responsive to a search for the term “poker” even through the term “poker” does not appear within the natural language content itself. Accordingly, the concepts identified as relevant to the natural language content may be used to more accurately classify the natural language content and/or to provide for more effective indexing of the natural language content. In addition, the relevant concepts may be used to identity similar content, provide targeted advertising, build a user profile, or the like.

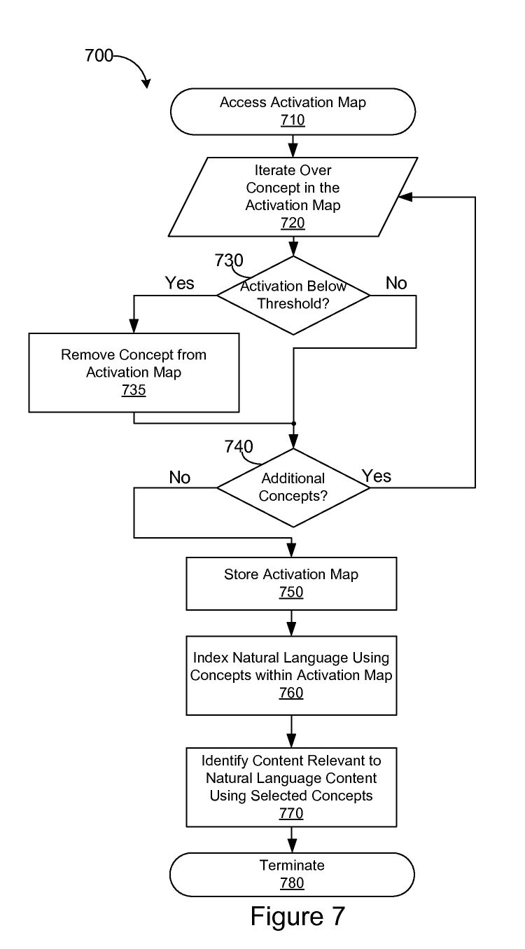

FIG. 7 is a flow diagram of one embodiment of a method 700 for processing an activation map generated using the systems and methods of this disclosure. The method 700 may comprise one or more machine executable instructions stored on a computer-readable storage medium. The instructions may be configured to cause a machine, such as a computing device, to perform the method 700. In some embodiments, the instructions may be embodied as one or more distinct software modules on the storage medium. One or more of the instructions and/or steps of method 700 may interact with one or more hardware components, such as computer-readable storage media, communications interfaces, or the like. Accordingly, one or more of the steps of method 700 may be tied to particular machine components.

At step 710, the method 700 may be initialized and/or may access an activation map comprising a plurality of concept vertices (or references to concept vertices within an ontology graph) and respective activation values. Step 710 may include parsing the natural language content to identify one or more candidate concepts as in method 301 described above in conjunction with FIG. 3B.

At step 720, the method 700 may iterate over each of the concepts within the activation map as described above (e.g., according to methods 500 and/or 600 described above). The iteration of step 720 may be configured to continue until a completion criteria has been reached (e.g., until an iteration threshold has been reached). Each of the iterations may comprise performing a recursive spreading activation function on each of the candidate concepts within the activation map.

At step 730, one or more representative concepts may be selected from the activation map. The selection may be based on various factors, including, but not limited to: the activation value of each concept within the activation map, proximity of the concepts in the ontology, activation value derivative, or the like. In some embodiments, the selection may include comparison of each activation value to an activation value threshold. As discussed above, the activation threshold of step 730 may be static (e.g., the same for each concept referenced in the activation map) or dynamic (e.g., adaptive according to the type of concept referenced in the activation map). For example, the activation threshold may be set at 0.2. At step 730, if the activation value of the current concept is below the threshold, the flow may continue to step 735; otherwise, the flow may continue to step 740.

At step 735, the concept reference may be removed from the activation map. This may prevent irrelevant concepts (e.g., having a low activation value) from being associated with the natural language content.

At step 740, if there are additional concepts in the activation map to be processed, the flow may return to step 730; otherwise, the flow may continue to step 750.

At step 750, the concepts remaining in the activation map (e.g., concepts having a higher activation value than the threshold) may be stored (e.g., on a computer-readable storage medium) for further processing. The concepts stored at step 750 may be those concepts relevant to the natural language content (e.g., selected at steps 730-740). In some embodiments, the storage of step 750 may comprise storing an activation value associated with each concept in the activation map. In this way, the concepts associated with the natural language content may be ranked relative to one another. Concepts having a higher activation value may be considered to be more relevant to the natural language content than those concepts having a lower activation value.

At step 760, the concepts may be used to classify the natural language content. The classification of step 760 may comprise indexing the natural language content according to the concepts stored at step 750. For example, the “Play Texas Hold'em get the best cards!” natural language content may be indexed using the “Texas Hold'em” concept, a “playing cards” concept, a “poker” concept, a “betting (poker)” concept, and the like. The indexing of step 760 may allow search engine to return the natural language content responsive to a search for a term that does not appear in the natural language content, but is deemed to be relevant to the natural language content (e.g., a search for “betting,” “poker,” or the like).

At step 770, the selected concepts may be used to identify content that is relevant to the natural language content. As discussed above, the relevant content may include, but is not limited to: other natural language content (e.g., webpages, articles, etc.), links (e.g., URLs, URIs, etc.), advertising, or the like. In some embodiments, the relevant content may be selected from a content index (e.g., library, repository, or the like), in which content is associated with one or more related concepts. The identification of step 770 may comprise comparing the concepts associated with the natural language content (e.g., identified at steps 720-750) with the concepts in the content index. Content that shares a common set of concepts with the natural language content may be identified. For example, a viewer of the “Texas Hold'em” natural language content discussed above, may be provided with content relating to the “online poker” concept or the like. The related content may be used to supply advertising to one or more users viewing the natural language content, provide related content (e.g., in a side bar or other interface), provide links to related content, or the like.

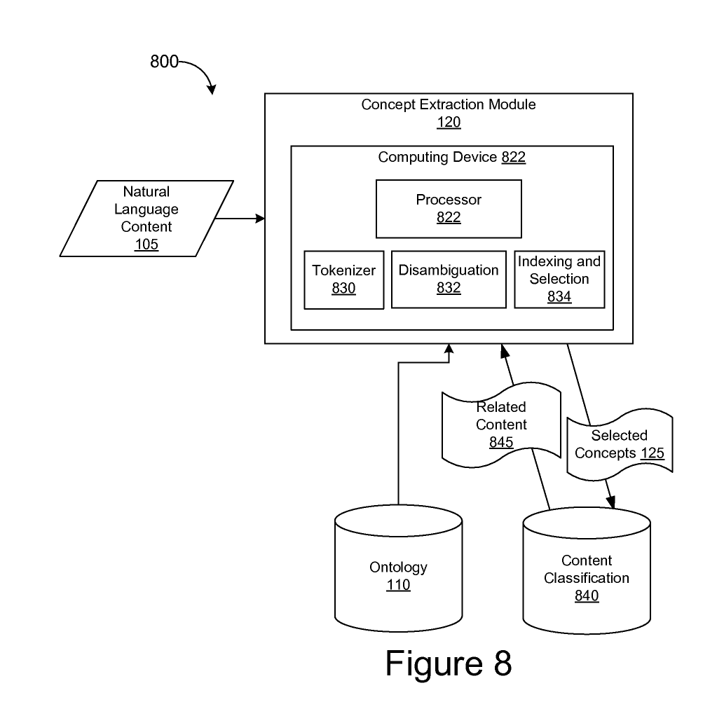

FIG. 8 is a block diagram of one embodiment of an apparatus for classifying natural language content and/or identifying related content. The apparatus 800 may include a concept extraction module 120, which may be implemented on and/or in conjunction with a computing device 822. The computing device 822 may include a processor 824, a computer-readable storage medium (not shown), memory (not shown), input/output devices (not shown), display interfaces (not shown), communications interfaces (not shown), or the like.

The concept extraction module 120 may include a tokenizer module 830, a disambiguation module 832, and an indexing and selection module 834. Portions of the modules 830, 832, and/or 834 may be operable on the processor 822. Accordingly, portions of the modules 830, 832, and/or 834 may be embodied as instructions executable by the processor 822. The instructions may be embodied as one or more distinct modules stored on the computer-readable storage medium accessible by the computing device 822. Portions of the modules 830, 832, and/or 834 may be implemented in hardware (e.g., as special purpose circuitry within an Application Specific Integrated Circuit (ASIC), a specially configured Field Programmable Gate Array (FPGA), or the like). Portions of the modules 830, 832, and/or 834 may interact with and/or be tied to particular machine components, such as the process 822, the computer readable media 110 and/or 840, and so on.

The tokenizer module 830 may be configured to receive and to tokenize the natural language content 105. Tokenizing the content by the tokenizer 830 may include removing stopwords, parts of speech, punctuation, and the like. The tokenizer module 830 may be further configured to identify within the ontology 110 concepts associated with the tokens (e.g., according to method 301 described above in conjunction with FIG. 3B). Single word tokens and/or phrases comprising multiple, adjacent tokens may be compared to concepts within the ontology 110. A token and/or phrase may match to a single concept within the ontology 110. Alternatively, a token may be associated with a plurality of different, competing concepts in the ontology 110. The concepts identified by the tokenizer module 830 may be stored in a graph (e.g., an activation map or sparse ontology graph).

The graph may flow to the disambiguation module 832, which may be configured to identity the concepts relevant to the natural language content 105 using the relationships between the identified concepts (e.g., according to methods 402, 500, and/or 700 described above in conjunction with FIGS. 4C, 5, and/or 7). The disambiguation module 832 may be configured to perform a spreading activation technique to identify the concepts relevant to the content 105. The spreading activation technique may be iteratively performed until a completion criteria is satisfied (e.g., for a threshold number of iterations, until a sufficient level of disambiguation is achieved, or the like). The disambiguation module 832 may be further configured to select relevant concepts 125 from the graph based on the activation value of the concepts or some other criteria. The selected concepts 125 (and/or the weights or activation values associated therewith) may be stored in a content classification data store 840. The content classification data store 840 may comprise computer-readable storage media, such as hard discs, memories, optical storage media, and the like.

The indexing and selection module 834 may be configured to index and/or classify the natural language content 105 using the selected concepts 125. The indexing and selection module 834 may store the natural language content 105 (or a reference thereto) in the content classification data store 840. The content classification data store 840 may associate the natural language content 105 (or reference thereto) with the selected concepts 125, forming a content-concept association therein. Accordingly, the natural language content 105 may be indexed using the selected concepts 125. The indexing and selection module 834 (or another module) may then use the selected concepts 125 to classify and/or provide search functionality for the natural language content 105 (e.g., respond to search queries, aggregate related content, or the like). For example, the “Online Poker” concept associated with the natural language content “Play Texas Hold'em get the best cards!,” may be used to return the natural language content 105 responsive to a search related to “online poker” despite the fact that “online poker” does not appear anywhere in the natural language content 105.

In some embodiments, the indexing and selection module 834 may be configured to select concepts related to a search query from a natural language search query (e.g., using the tokenizer 830 and/or disambiguation module 832 as described above). The concepts identified within the search query may be used to identify related content in the content classification data store 840. The identification may comprise comparing concepts associated with the search query to concept-content associations stored in the content classification data store 840.

The indexing and selection module 834 may be further configured to identify content 845 that is relevant to the natural language content 105. As discussed above, relevant content 845 may include, but is not limited to: other natural language content, multimedia content, interactive content, advertising, links, and the like. The indexing and selection module 834 may identify relevant content 845 using the selected concepts 125 associated with the natural language content 105 (e.g., using the content-concept associations within the content classification data store 840). For instance, the content classification data store 840 may include various concept-content associations for other content (e.g., other natural language content, advertising, and so on). The associations may be determined a priori and/or may be determined using the systems and methods disclosed herein. The concept-to-content associations in the content classification data store 840 may be searched using the selected concepts 125. An overlap between the selected concepts 125 and concepts associated with content identified in the content classification data store 840 (or other data store) may be identified as relevant content 845. The relevant content 845 may be provided to a user, may be displayed in connection with the natural language content 105 (e.g., in a side bar), may be linked to the natural language content 105, or the like.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a processor within a general-purpose or special-purpose computing device, such as a personal computer, a laptop computer, a mobile computer, a personal digital assistant, smart phone, or the like. Alternatively, the steps may be performed by hardware components that include specific logic for performing the steps, or by a combination of hardware, software, and/or firmware.

Embodiments may also be provided as a computer program product including a computer-readable medium having stored instructions thereon that may be used to program a computer (or other electronic device) to perform processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of this disclosure.

We claim:

1. A computer-readable storage medium comprising instructions to cause a computing device to perform a method for identifying concepts representative of natural language content using an ontology, the ontology comprising a plurality of interconnected concepts, the method comprising:
tokenizing the natural language content into one or more tokens;
identifying one or more concepts in the ontology using the tokens;
selecting one or more concepts representative of the natural language content from the ontology using the identified concepts and connections between the concepts in the ontology; and
indexing the natural language content using the representative concepts.

2. The computer-readable storage medium of claim 1, further comprising:
generating a graph comprising a plurality of interconnected concepts, wherein the concepts in the graph are selected from the ontology using the tokens, and wherein connections between the plurality of concepts in the graph are determined by the ontology;
wherein the concepts representative of the natural language content are selected from the graph.

3. The computer-readable storage medium of claim 1, further comprising:
assigning an activation value to one or more of the identified concepts; and
spreading the activation values to other concepts within the ontology;
wherein the representative concepts are selected based upon an activation value of the representative concepts.

4. The computer-readable storage medium of claim 3, wherein the activation value of a particular concept is spread to each of the concepts connected to the particular concept in the ontology.

5. The computer-readable storage medium of claim 4, wherein the activation value spread from the particular concept is proportional to the number of concepts connected to the particular concept in the ontology.

6. The computer-readable storage medium of claim 4, wherein the activation value of the particular concept is recursively spread to concepts connected to the particular concept and within a predetermined number of generations of the particular concept in the ontology.

7. The computer-readable storage medium of claim 6, wherein the activation value recursively spread from the particular concept to a second concept is proportional to the number of generations separating the particular concept and the second concept.

8. The computer-readable storage medium of claim 4, wherein the activation value recursively spread from the particular concept is recursively spread to concepts connected to the particular concept in the ontology and that are within two generations of the particular concept in the ontology.

9. The computer-readable storage medium of claim 4, wherein the activation value of the particular concept is spread to each of the concepts connected to the particular concept in the ontology according to a spreading activation function.

10. The computer-readable storage medium of claim 9, wherein the spreading activation function is a stepwise spreading activation function of the form:
$${W}_{n} = \frac{0.7 \cdot {W}_{P}}{log ( 1 + N )} .$$

11. The computer-readable storage medium of claim 3, further comprising iteratively spreading the activation values to other concepts within the ontology for a predetermined number of iterations.

12. The computer-readable storage medium of claim 11, further comprising normalizing the activation values of each of the concepts after each iteration.

13. The computer-readable storage medium of claim 11, further comprising weighting the representative concepts using the activation values of the relevant concepts.

14. The computer-readable storage medium of claim 3, wherein a first token is used to identify a single concept in the ontology and a second token is used to identify a plurality of competing concepts in the ontology, and wherein the concept identified using the first token is assigned a first activation value and each of the competing concepts identified using the second token are assigned a different, second activation value smaller than the first activation value.

15. The computer-readable storage medium of claim 14, wherein the second activation value is proportional to the number of completing concepts identified using the second token.

16. The computer-readable storage medium of claim 1, wherein tokenizing comprises selecting one or more terms from the natural language content, wherein selecting the one or more terms comprises removing each of stopwords, parts-of-speech, and punctuation from the natural language content.

17. The computer-readable storage medium of claim 1, wherein tokenizing comprises constructing a token comprising one or more terms from the natural language content.

18. The computer-readable storage medium of claim 1, further comprising identifying related content using the representative concepts of the natural language content.

19. The computer-readable storage medium of claim 18, further comprising providing the identified related content for display in connection with the natural language content.

20. The computer-readable storage medium of claim 18, wherein the related content is selected from the advertising, a link, multimedia content, and natural language content.

21. A computer-implemented method for identifying concepts relevant to natural language content, the method comprising:
tokenizing the natural language content into a plurality of tokens;
identifying within an ontology stored on a computer-readable storage medium, one or more concepts associated with each of the tokens, wherein the ontology is embodied as a graph comprising a plurality of interconnected vertices, wherein each vertex in the graph represents a concept, and wherein interconnections between the concepts in the ontology represent relationships between concepts;
selecting from the ontology one or more concepts relevant to the natural language content based on the concepts identified using the plurality of tokens and the interconnections in the ontology; and
providing for displaying one or more indicators of related content in connection with the natural language content, wherein the indicators are selected using the relevant concepts.

22. The method of claim 21, wherein selecting from the ontology one or more concepts relevant to the natural language content comprises:
applying an activation value to each of the identified concepts in the ontology; and
iteratively spreading the activation values to other concepts within the graph;
wherein the concepts relevant to the natural language content are selected using the activation values of the concepts.

23. The method of claim 22, wherein iteratively spreading the activation value from a particular concept comprises incrementing an activation value of each concept connected to the particular concept in the ontology according to an activation function.

24. The method of claim 23, wherein the activation value spread from the particular concept to a concept connected to the particular concept is proportional to the activation value of the particular concept.

25. The method of claim 23, wherein the activation value spread from the particular concept to a concept connected to the particular concept is proportional to the number of concepts connected to the particular concept in the ontology.

26. The method of claim 23, wherein the spreading activation function is a stepwise activation function of the following form:
$${W}_{n} = \frac{0.7 \cdot {W}_{P}}{log ( 1 + N )} .$$

27. The method of claim 22, wherein during each iteration, the activation values of each concept are recursively spread to concepts connected to the activated concepts within the ontology, wherein the recursive spreading continues for a predetermined number of generations within the ontology.

28. The method of claim 27, where the recursion continues for two generations within the ontology.

29. The method claim 21, wherein a first activation value is applied to a concept unambiguously identified in the ontology using a first token, and a second, different activation value is applied to a plurality of completing concepts ambiguously identified in the ontology using a second token, wherein the first activation value is greater than the second activation value, and wherein the second activation value is proportional to the number of competing concepts ambiguously identified using the second token.

30. The method of claim 29, wherein the first activation value is one, and wherein the second activation value is one divided by the number of completing concepts ambiguously identified in the ontology using the second token.

31. An apparatus for determining one or more concepts related to natural language content, comprising:
a computer-readable storage medium comprising an ontology;
a computing device comprising a processor communicatively coupled to the computer-readable storage medium;
a tokenizer module operable on the processor, the tokenizer module configured to tokenize the natural language content into a plurality of tokens and to identify within the ontology one or more candidate concepts associated with each of the plurality of tokens; and
a disambiguation module operable on the processor and communicatively coupled to the tokenizer module, wherein the disambiguation module is configured to select one or more concepts related to the natural language content from the ontology using the ontology and the one or more identified concepts.

32. The apparatus of claim 31, further comprising an indexing module operable on the processor and communicatively coupled to the disambiguation module, wherein the indexing module is configured to index the natural language content using the concepts related to the natural language content.

33. The apparatus of claim 32, wherein the indexing module is configured to select content related to the natural language content using the concepts related to the natural language content.

34. The apparatus of claim 31, wherein the disambiguation module is configured to,
assign an activation value to each of the candidate concepts,
iteratively spread the activation values to other concepts in the ontology; and
select the one or more concepts related to the natural language content based upon activation values of the concepts.

35. The apparatus of claim 34, wherein in each iteration of spreading the activation values, activation values are spread from each concept having an activation value to concepts connected thereto in the ontology, and
wherein the activation value spread from a first concept to a second concept is proportional to the activation value of the first concept and the number of concepts connected to the first concept in the ontology.

36. The apparatus of claim 35, wherein in each iteration of spreading the activation values, activation values are recursively spread from each concept having an activation value to concepts connected thereto in the ontology and that are within a predetermined number of generations thereto in the ontology, and
wherein the activation value spread from the first concept to the second concept is proportional to the number of generations separating the first concept and the second concept in the ontology.

37. The apparatus of claim 34, wherein the disambiguation module is configured to normalize the activation values of the concepts after each iteration of spreading the activation values.

38. A computer-readable storage medium comprising instructions to cause a computing device to perform a method for selecting concepts relevant to natural language content using an ontology embodied as a graph of interconnected concepts, the method comprising:
generating a graph comprising a plurality of candidate concepts for the natural language content using the ontology and a plurality of tokens parsed from the natural language content;
assigning each of the candidate concepts in the graph an initial activation value;
spreading the activation values of each of the concepts having an activation value to other concepts within the graph, wherein the activation value of a particular concept is spread to each concept connected to the particular concept in the graph; and
selecting one or more concepts from the graph as representative concepts for the natural language content, wherein the selection of representative concepts is based on activation values of the concepts in the graph.

39. The computer-readable storage medium of claim 38, wherein the activation values of each of the concepts having an activation value are spread to concepts connected thereto in the graph, and wherein the connections between the concepts in the graph are determined by the ontology.

40. The computer-readable storage medium of claim 39, wherein the graph comprises an activation map, and wherein the activation map is generated using the ontology.

41. The computer-readable storage medium of claim 39, wherein the graph comprises a sparse ontology graph.

42. The computer-readable storage medium of claim 39, wherein the activation values are recursively spread to a predetermined number of generations of concepts within the graph.

43. The computer-readable storage medium of claim 42, wherein the activation values are recursively spread to two generations of concepts within the graph.

44. The computer-readable storage medium of claim 39, further comprising:
iteratively spreading the activation values for a predetermined number of iterations; and
normalizing the activation values of the concepts within the graph following each iteration.

45. A system for identifying concepts relevant to natural language content using an ontology comprising a plurality of interconnected concepts, the system comprising:
a computing device comprising a processor; and
a disambiguation module operable on the processor and configured to select concepts related to the natural language content from the ontology;
wherein the disambiguation module is configured to select the concepts related to the natural language content by,
identifying one or more candidate concepts within the ontology using terms from the natural language content,
applying an activation value to each of the candidate concepts,
iteratively spreading the activation values to concepts within the ontology based on the connections between the concepts in the ontology, and
selecting the concepts related to the natural language content using activation values of the concepts in the ontology.

46. The system of claim 45, wherein the activation value of a first concept having an activation value is spread to each of the concepts connected to the first concept in the ontology.

47. The system of claim 46, wherein the activation value spread from the first concept to the concepts connected to the first concept in the ontology is proportional to the activation value of the first concept and the number of concepts connected to the first concept in the ontology.

48. The system of claim 47, wherein the activation value of the first concept is recursively spread to multiple generations of concepts connected the first concept in the ontology, and wherein the activation value spread from the first concept to a second concept is proportional to the number of generations between the first concept and the second concept.

49. The system of claim 46, wherein the activation value spread from the first concept to the concepts connected to the first concept in the ontology is determined by a stepwise activation function.

50. The system of claim 45, wherein the activation values are iteratively spread to other concepts in the ontology for a predetermined number of iterations.

51. The system of claim 45, wherein the activation values are iteratively spread until a completion criteria is satisfied, and wherein the completion criteria is based upon one selected from an activation differential between competing concepts in the ontology and a derivative of an activation value of one or more concepts in the ontology.

52. A computer-readable storage medium comprising instructions to cause a computing device to perform a method for selecting related concepts from a graph comprising a plurality of vertices, each vertex representing a concept in an ontology, wherein the vertices are interconnected by a plurality of edges, and wherein the interconnections between the vertices are determined by the ontology, the method comprising:
assigning an activation value to one or more of the vertices in the graph;
iteratively spreading the activation values of each of the vertices in the graph to other vertices in the graph until a completion criteria is satisfied, wherein spreading the activation value of a first vertex in the graph comprises incrementing an activation value of each vertex in the graph that is connected to the first vertex and that is within a predetermined number of generations of the first vertex in the graph;
selecting one or more concepts from the graph based upon the activation values of the concepts within the graph; and
indexing the natural language content using the relevant concepts.

53. The computer-readable storage medium of claim 52, wherein the completion criteria comprises an iteration threshold of three iterations.

54. The computer-readable storage medium of claim 52, wherein the activation value spread from a first vertex in the graph to a second vertex connected to the first vertex in the graph is determined by a stepwise activation function.

55. The computer-readable storage medium of claim 52, wherein the activation value spread from a first vertex in the graph to a second vertex connected to the first vertex in the graph is determined by the activation value of the first vertex, the number of concepts connected to the first vertex in the graph, and the number of generations between the first vertex and the second vertex in the graph.

56. A computer-readable storage medium comprising instructions to cause a computing device to perform a method, comprising:
crawling one or more knowledge sources;
identifying within the one or more knowledge sources a plurality of related concepts;
constructing an ontology using the plurality of related concepts, the ontology comprising a plurality of interconnected concepts; and
using the ontology to identify concepts relevant to natural language content.

57. The computer-readable storage medium of claim 56, wherein connections between the plurality of concepts are determined using links between concepts in the one or more knowledge sources.

58. The computer-readable storage medium of claim 57, wherein the links between concepts in the one or more knowledge sources comprise a uniform resource identifier.

59. The computer-readable storage medium of claim 56, wherein one or more of the knowledge sources comprises an online encyclopedia.

60. The computer-readable storage medium of claim 56, wherein one or more of the knowledge sources comprises an online dictionary.
